(19) United States
(12) Patent Application Publication
(10) Pub. No.: US 2007/0050947 A1
(43) Pub. Date: Mar. 8, 2007

(54) Two Bar Stays and Associated Methods

(75) Inventor: Stephen John Moore, Cheltenham (GB)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: Securistyle Ltd, Cheltenham (GB)

(21) Appl. No.: 11/470,357

(22) Filed: Sep. 6, 2006

(30) Foreign Application Priority Data
Sep. 7, 2005 (GB) 0518292.8
Mar. 3, 2006 (GB) 0604331.9

(51) Int. Cl. E05D 11/06

(52) U.S. Cl. 16/371

(57) ABSTRACT

The present invention describes two bar stays that include a slider within a track, wherein the track comprises a base and two side walls substantially perpendicular to the base and wherein at least one of the side walls is flanged to provide a partially closed channel. The two bar stays have advantages with regard to ease of manufacture, ease of assembly, ease of use, stability and strength.

### FIELD OF THE INVENTION

The present invention relates to two bar stays for supporting a sash or a vent between a closed position and an open position.

### BACKGROUND OF THE INVENTION

Commercially available two bar stays generally comprise a vent arm, a link and a track, wherein the link is immovably fastened to said track at a pivot point and the vent arm is mounted on a slider that may move along the track. The link is joined to the vent arm at a point along its length. The tracks of these stays have one side wall which possesses a region flanged to form a U section that is adapted to receive a slider, said slider possessing a lip in order to restrain it within the U section. A disadvantage of these stays is that as the slider is only restrained upon one side there is scope for substantial free play of the two bars from the frame, causing significant instability when the stay is used to support a vent.

A further disadvantage of these stays is that they are either right or left handed rather than being universally fittable. The fixing of the link to the track may also be disadvantageous with regard to ease of assembly, particularly when fitting the vent within a fixed frame. Additionally, when the two bar stay is fully open, the vent lies substantially at one side of the fixed frame and therefore the outer surface of the vent, e.g. a window, cannot be easily accessed to allow cleaning. This disadvantage becomes particularly important in situations where access to the exterior of the vent is difficult or impossible, for example in a high rise building.

### SUMMARY OF THE INVENTION

In view of the foregoing, the present invention provides a two bar stay comprising a slider within a track, wherein the track comprises a base and two side walls substantially perpendicular to the base and wherein at least one of the side walls is flanged to provide a partially closed channel. Preferably, both side walls are flanged. More preferably the flanges face each other. The two bar stay can support a sash or vent between a closed position, in which it lies within a fixed frame, and an open position, in which it extends substantially perpendicular to the fixed frame. The two bar stays of the present invention have advantages with regard to ease of manufacture, ease of assembly, ease of use, stability and strength, amongst other benefits.

The slider preferably includes a friction adjusting device to control the movement of the slider along the support track. In this way, the speed at which the vent arm moves along the support track can be controlled.

The two bar stay preferably includes a second slider, which may support an end of a link. A releasable restricting means may act between the second slider and the track to allow the second slider to be locked into at least one position on the track to form a fixed pivot. Preferably, the releasable restricting means is attached to the second slider and moves along the track therewith. More preferably the releasable restricting means is formed integrally with the second slider. The releasable restricting means may be operated by a push button or by a twisting, screwdriver operated mechanism.

The track may be shaped to receive a releasable restricting means. The releasable restricting means may include ears that engage the track, limiting the motion of the second slider. If the track includes a bottom, two side walls and a pair of inwardly facing flanges, the inwardly facing flanges are preferably shaped to receive the ears of the releasable restricting means. The releasable restricting means may also, or alternatively, comprise a spring clip that may engage with cut out regions of the side walls that are adapted to receive it. At least one of the sliders may be shaped to avoid obstacles in the base of the track. This has the advantage of avoiding a clash between the slider and screw heads holding the track in place in a fixed frame.

Preferably at least one slider possesses a lip shaped to grip the flanged area. This lip restricts any rotational motion of the slider within the track and provides the advantage of preventing friction and wear between the link and the track when the vent arm is under load. At least one slider may comprise a nylon thermoplastic.

Preferably, at least one of the track and bars (i.e. the link or vent arm) comprises austenitic stainless steel. Additionally, at least one of the sliders may also comprise austenitic stainless steel. The track may be adapted for mounting to a larger structure and at least one of the bars, e.g. the vent arm, is preferably adapted for supporting a sash.

The two bar stay is preferably substantially universally fittable.

A method of assembling a two bar stay may comprise the steps of: locating a first slider in a track; moving the first slider until a second slider can be located in the track; and moving the second slider until the releasable restricting mechanism locates within an area of the track shaped to receive it. Preferably the track has at least one cut out region on its uppermost surface for receiving the sliders and thereby facilitating assembly.

### BRIEF DESCRIPTION OF THE DRAWINGS

Specific embodiments of the present invention are now described by way of example with reference to the accompanying drawings in which:

FIG. 1 is a plan view of a first embodiment.

FIG. 2 is a perspective from above of a first embodiment.

FIG. 3 is an enlarged fragmentary perspective view in the direction of arrow A in FIG. 2.

FIG. 4 is a plan view of a first embodiment in an alternative configuration.

FIG. 5 is a perspective from above of a first embodiment in an alternative configuration.

FIGS. 6, 7, and 8 are planned views of a first embodiment during assembly.

FIG. 9 is a fragmentary perspective view from below of a friction slider of the first embodiment.

FIG. 10 is a fragmentary perspective view from below of a pivot slider of the first embodiment.

FIG. 11 is a perspective from above of a second embodiment.

FIG. 12 is a perspective from above of a second embodiment in an alternative configuration.

FIG. 13 is a perspective view of the pivot slider of the second embodiment.

FIG. 14 is a view on arrow B in FIG. 13.

FIG. 15 is a perspective view of the friction slider of the second embodiment.

FIG. 16 is a further perspective view of the friction slider of the second embodiment; and

FIG. 17 is a view on arrow C in FIG. 16.

### DETAILED DESCRIPTION OF THE PREFERRED EMBODIMENTS

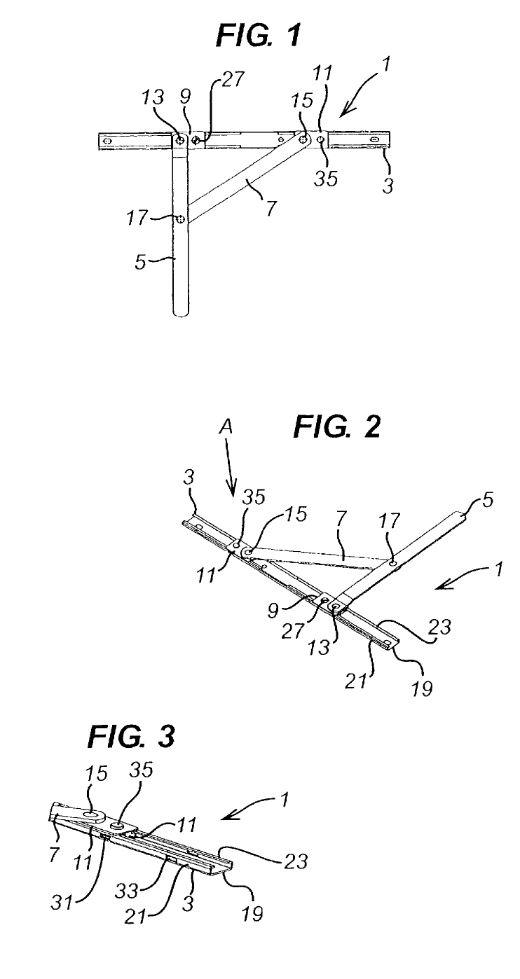

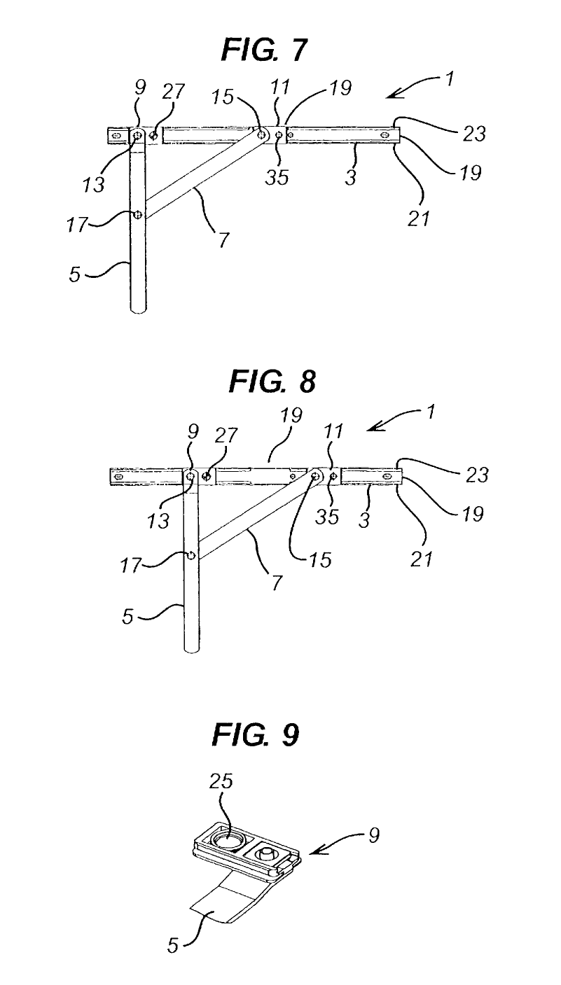

With reference to FIGS. 1-10, a first embodiment of a two bar stay 1 of the present invention comprises a support track 3, a vent arm 5, a link 7, a first slider 9 and a second slider 11. The vent arm 5 is pivotally attached to the slider 9 by a rivet 13. The link 7 is attached to the slider 11 by a rivet 15 at one end and its other end is pivotally attached by a rivet 17 to a midpoint of the vent arm 5. The first and second sliders 9, 11 are positioned within the support track 3.

The support track 3 comprises a base 19 and two side walls 21 which possess a pair of flanges 23 that face each other to form a C section. The first and second sliders 9, 11 are shaped to be received in the support track 3 and to be held therein by means of the flanges 23. The sides of the first and second sliders 9, 11 are lipped to give a U shape that grips the flanges 23, preventing the vertical displacement (i.e., free play) seen in sliders of the prior art and constraining the sliders to moving in one dimension along the track. Additionally, the tops of the first and second sliders 9, 11 are positioned such that they prevent friction and wear between the link 7 and the flanges 23.

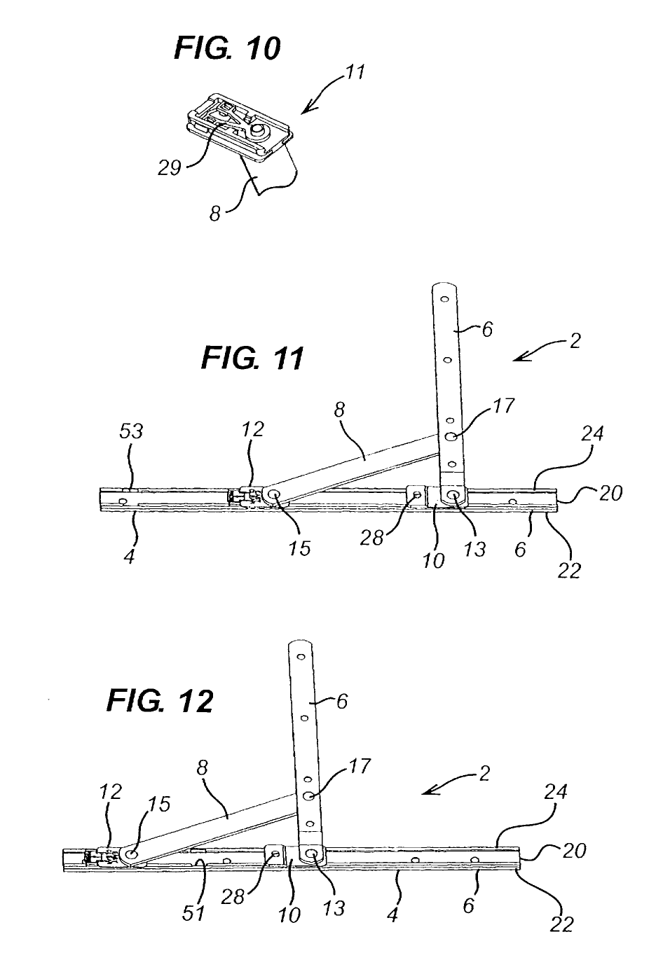

The first slider 9 (see FIG. 9) possesses a friction cam 25 that can be operated by screw 27 using a standard screwdriver (not shown) to flex the sides of the first slider 9 outwards thus increasing their friction with the side walls 21 of the support track 3. The second slider 11 (see FIG. 10) possesses a releasable restricting means in the form of a spring clip 29 that engages with cut out regions 31 in the side walls 21. The spring clip 29 can be retracted from the cut out regions 31 by operation of a release button 35. When the spring clip 29 is received in the cut out regions 31, the second slider 11 is held in position in the support track 3 and acts as a pivot. The first slider 9 is, however, still free to move along the support track 3, thereby moving the vent arm 5 between its open and closed positions.

In the closed position, the vent arm 5 lies above the link 7, which in turn lies above the support track 3 and the three components lie substantially in parallel. On opening the vent, the first slider 9 moves towards the second slider 11 and the vent arm 5 moves outwardly until it is substantially perpendicular to the support track 3 and the vent (not shown) is in its fully open position.

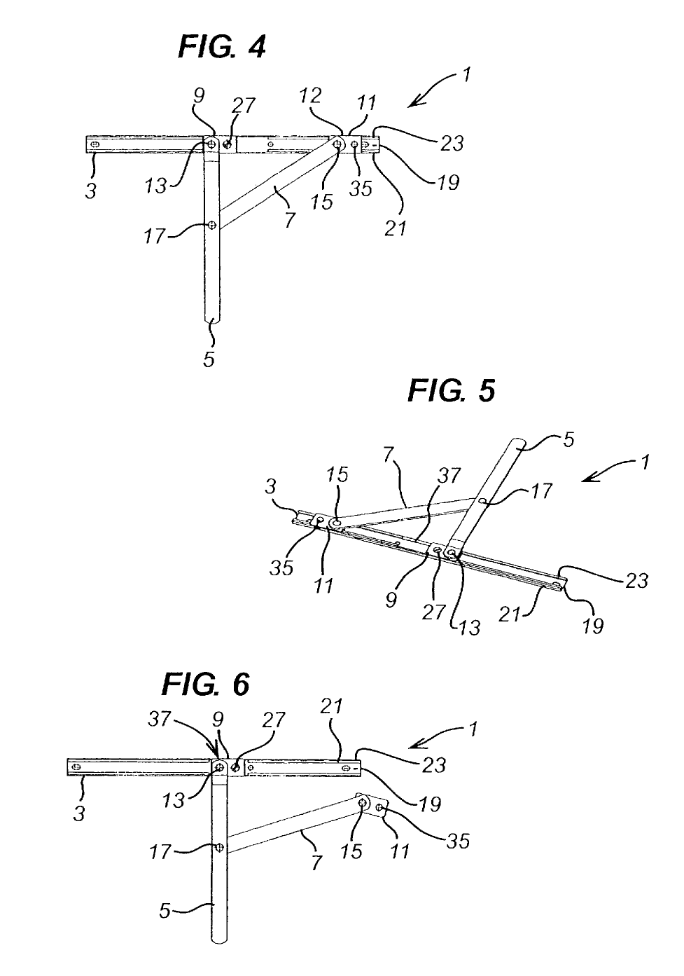

When the two bar stay 1 is fully open (as shown in FIGS. 1 and 2), the vent mounted on the vent arm 5 allows egress as it is supported at one side of the fixed frame (not shown) to which the support track 3 is attached and therefore does not hinder entry or exit through the frame. In order to allow the outside surface of the vent, such as a window, to be cleaned, the release button 35 can be depressed to disengage the spring clip 29 from the cut out regions 31 in the side walls 21. The vent arm 5, the link 7 and the first and second sliders 9, 11 can then be moved, along with the vent itself, relative to the support track 3 until the spring clip 29 locates in a second set of cut out regions 33 (shown in FIG. 3). The vent arm 5 is now positioned somewhere near to the middle of the support track 3 (as shown in FIGS. 4 and 5) and access is readily available to both sides of the vent.

Once the cleaning of the vent has been achieved, the release button 35 can be depressed again to disengage the spring clip 29 from the second cut out regions 33 and the whole assembly can be slid back along the support track 3 to its original position. When the spring clip 29 has relocated in the cut out regions 31, the vent can be returned to standard operation.

The two bar stay 1 is advantageous with regard to ease of assembly (shown in FIGS. 6 to 8). The first slider 9 can be placed in the support track 3 at the cut out regions 37 in the flanges 23. The first slider 9 is then slid along the support track 3 to allow the second slider 11 to be aligned with the cut out regions 37 and then placed in the support track 3. The chamfered edges of the spring clip 29 enable the second slider 11 to locate in the support track 3 without the release button 35 needing to be depressed. The assembly is then moved along the track until the spring clip 29 self locates in the cut out regions 31 in the side walls 21.

In a second embodiment of the present invention, shown in FIGS. 11-17, the two bar stay 2 comprises a support track 4, vent arm 6, a link 8, an alternative first slider 10 and an alternative second slider 12 (shown in FIG. 11). The first slider 10 includes a spring clip 39 (shown in FIG. 15) that forces the flexible legs 41 against the side walls 22 of the support track 4 (FIG. 15). The screw 43 allows an adjustable amount of force to be placed on the spring clip 39 thus providing adjustable friction (FIG. 16).

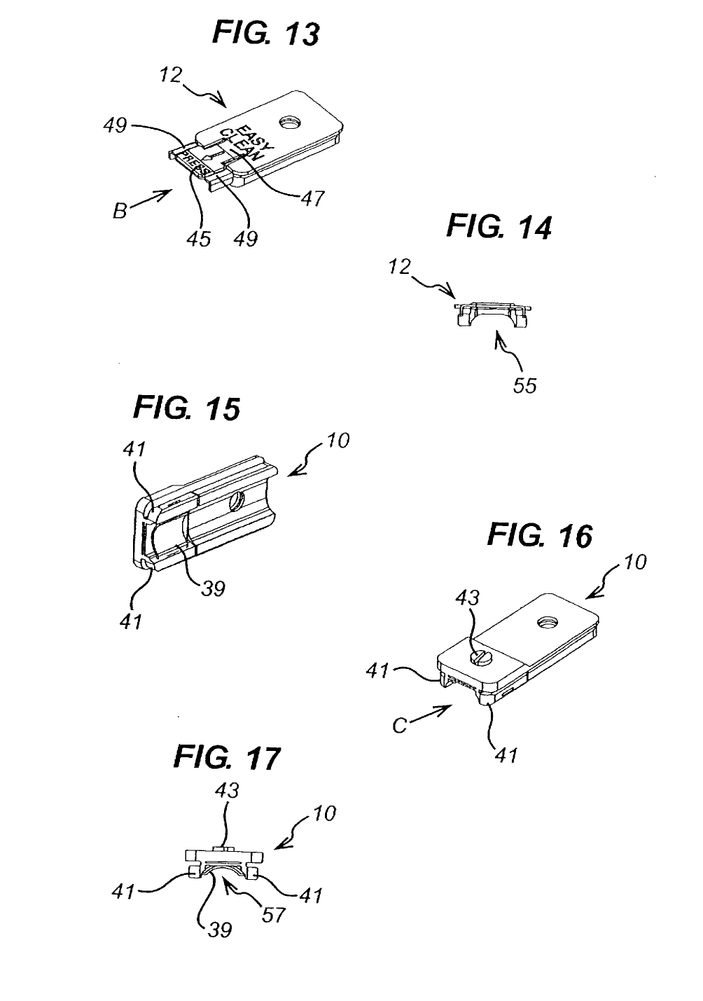

The second slider 12 is formed integrally with a releasable restricting means 45 that comprises a neck region 47 and two ears 49 extending perpendicular thereto (FIG. 13). The neck 47 extends from a region of the second slider 12 and is coplanar with it.

The ears 49 of the restricting means 45 can engage with cut out regions 51 in the flanges 28, thereby holding the second slider 12 in position and causing it to act as a pivot. The first slider 10 is, however, still free to move along the support track 4, thereby moving the vent arm 6 between its open and closed positions. In a similar fashion to the first embodiment, there is also a mechanism to allow the outer surface of the vent to become accessible for cleaning. When the two bar stay 2 is fully open, with the vent arm 6 substantially perpendicular to the support track 4, the restricting means 45 can be depressed into the support track 4. The ears 49 then disengage from the cut out regions 51 and the second slider 12 is free to move along the support track 4 with the ears 49 of the restricting means 45 continuously biased against the undersides of the flanges 24. The vent arm 6, the link 8 and the first and second sliders 10,12 can then be moved, along with the vent itself, relative to the support track 4 until the ears 49 locate in a second set of cut out regions 53 (FIGS. 11 and 12). Access is thereby facilitated to both sides of the vent.

The first and second sliders 10, 12 comprise a composite stainless steel insert covered by a durable nylon thermoplastic moulding. They are channelled at 55 and 57 respectively so that they can pass freely over the fixing screws (not shown) holding the support track 4 in place (FIGS. 14 and 17).

The embodiments described above are advantageous in terms of being substantially universally fittable, providing access to the exterior surface of a vent for washing and providing stable support for a vent by both sides of the sliders being held in place by the track.

It will of course be understood that the present invention has been described purely by way of example and that modifications of detail can be made within the scope of the invention that is defined by the following claims.

What is claimed is:

1. A two bar stay comprising a track and a slider at least partially positioned therewithin, wherein the track comprises a base and two side walls substantially perpendicular to the base and wherein at least one of the side walls is flanged to provide a partially closed channel.

2. A two bar stay as recited in claim 1, wherein both side walls are flanged.

3. A two bar stay as recited in claim 2, wherein the flanges face each other.

4. A two bar stay as recited in claim 1, wherein the slider further comprises a friction adjusting device.

5. A two bar stay as recited in claim 1, further comprising a second slider at least partially positioned within the track.

6. A two bar stay as recited in claim 5, further comprising a releasable restricting means operative between the second slider and the track to allow the second slider to be locked into at least one position in the track to form a fixed pivot.

7. A two bar stay as recited in claim 6, wherein the releasable restricting means is attached to the second slider and moves along the track therewith.

8. A two bar stay as recited in claim 7, wherein the releasable restricting means is formed integrally with the second slider.

9. A two bar stay as recited in claim 6, wherein the track is shaped to receive the releasable restricting means.

10. A two bar stay as recited in claim 9, wherein the side walls of the track are shaped to receive the releasable restricting means.

11. A two bar stay as recited in claim 9, wherein each flange is shaped to receive the releasable restricting means.

12. A two bar stay as recited claim 1, wherein the slider is shaped to avoid obstacles on the base of the track.

13. A two bar stay as recited in claim 1, wherein the slider possesses a lip adapted to grip the flanged area.

14. A two bar stay as recited in claim 1, wherein the slider comprises a nylon thermoplastic.

15. A two bar stay as recited claim 1, wherein the track comprises austenitic stainless steel.

16. A two bar stay as recited claim 1, wherein the track is adapted for mounting to a larger structure.

17. A two bar stay as recited in claim 1, wherein at least one of the two bars is adapted for supporting a sash.

18. A two bar stay as recited in claim 1, wherein the track is substantially universally fittable.

19. A method of assembling a two bar hinge comprising the steps of:
locating a first slider in a track;
moving the first slider until a second slider can be located in the track; and
positioning the second slider so that a releasable restrictor affixed to the second slider is received within an area of the track adapted to receive the restricotor.

20. A method as recited in claim 19, wherein the second slider comprises a retractable protrusion, and the area of the track adapted to receive the restrictor comprises at least one cutout region on an upper surface for receiving the retractable protrusion.
